(19) United States
(12) Patent Application Publication
(10) Pub. No.: US 2003/0009999 A1
(43) Pub. Date: Jan. 16, 2003

(54) Dust collection system for a bolting machine

(76) Inventors: Brad Neilson, Gwynneville,NSW (AU); Matthew Langbridge, Unanderra,NSW (AU)

Correspondence Address: JAMES EARL LOWE, JR., 15417 W NATIONAL AVE # 300, NEW BERLIN, WI, 53151, US

(21) Appl. No.: 10/204,897

(22) PCT Filed: Feb. 23, 2001
(86) PCT No.: PCT/AU01/00186

(30) Foreign Application Priority Data
Feb. 25, 2000 (AU) 19497/00

(51) Int. Cl. B01D 50/00

(52) U.S. Cl. 55/385.5

(57) ABSTRACT

A mining apparatus dust collection component including a vessel to receive and circulate an airflow and an entrained particulate material; said vessel separating said particulate material from airflow by a centrifugal effect said vessel including an inlet and an outlet for said airflow said component including attachment means to attach a detachable bag to said vessel said detachable bag preventing air passing through it. A mining apparatus dust collection system including: at least one inlet associated with a respective drilling unit to draw air and dust into said system from a drill bit when said drilling unit is in use; at least a first stage of dust removal being a mining dust collection component as described connected to at least one of said inlet; a vacuum pump to draw air and dust from said drilling unit. A method of operating a dust collection system said method including the collection of dust particles during a drilling operation passing same to at least one separator being a first stage, the output of the at least one separators being passed to a filtration unit being a second stage, the filtration unit passing filtered air through to a vacuum pump.

### FIELD OF THE INVENTION

This invention relates to a dust collection system which can be used with a bolting machine. While the discussion below is directed to bolting machines, it will be readily understood that the present invention is applicable to other mining apparatus other than just bolting machines.

### BACKGROUND OF THE INVENTION

In recent times, the presence of fine particles in the air in a work environment have been found to cause health problems and difficulties to workers. This has impacted upon the operations of mines and mining companies. In some countries like the USA, laws or regulations limit the amount of air borne silica dust that is permitted to be in the work environment around miners and people engaged in mining operations.

### SUMMARY OF THE INVENTION

The present invention provides a mining apparatus dust collection component including a vessel to receive and circulate an airflow and an entrained particulate material; said vessel separating said particulate material from airflow by a centrifugal effect, said vessel including an inlet and an outlet for said airflow said component including attachment means to attach a detachable bag to said vessel said detachable bag preventing air passing through it.

The detachable bag is preferably sealable after detachment from said vessel.

The detachable bag can include a zipper to seal said bag after detachment from said vessel.

The vessel or the bag can include a means to keep said bag in an open condition. The means can be a structure such as a wire frame which sits inside said bag, or it may be the parts of the housing containing the separator to which the outside of the bag can attach.

The invention also provides a mining apparatus dust collection system including: at least one inlet associated with a respective drilling unit to draw air and dust into said system from a drill bit when said drilling unit is in use; at least a first stage of dust removal being a mining dust collection component as described previously connected to at least one of said inlet; a vacuum pump to draw air and dust from said drilling unit.

The mining apparatus dust collection system can be such that each dust collection component feeds outgoing air exiting said first stage into a single filter or separation component being a second stage.

The vacuum pump is preferably downstream of the second stage.

The at least one inlet preferably has a similar sized opening as provided through said drill unit and a drill bit connected to said drill unit.

A restrictor or variable restrictor can be provided with communicable passage to said inlet and through which air and entrained particulate material will flow.

Preferably there is included a third stage of filtration or separation whereby air exiting said vacuum pump passes through a filter before exiting said dust collection system.

The invention further provides a method of operating a dust collection system said method including the collection of dust particles during a mining operation passing same to at least one separator being a first stage, the output of the at least one separator flowing to a filtration unit being a second stage, the filtration unit passing filtered air through to a vacuum pump.

Preferably there is included a third stage of filtering or separation downstream of the outlet of the vacuum pump.

Preferably at least one separator of said first and or said second stage and or said third stage has a door to cover an outlet therefrom whereby when a predetermined operation occurs on the mining apparatus the outlet will open thus depositing any separated particulate onto the ground.

The emptying operation can be automatically timed to be completed before the next said predetermined operation begins.

The apparatus can be a bolting apparatus. Said predetermined operation can be the retraction of a temporary roof support. In this case preferably said outlet closes the next time that the temporary roof support is moved so as to re-engage a mine roof.

Preferably the first and or second stage separators will discharge separated particulate into a sealable container. Alternatively the first or second stage separators can discharge the separated particulate onto the ground. Alternatively a combination of both discharge methods can be used.

Preferably the absence or rupture of one container prevents a mining operation from occurring. The containers are preferably flexible sealable bags.

In this specification and claims, where the words “comprising”, “comprised” or words derived therefrom are used, those terms are to be interpreted inclusively rather than exclusively.

### BRIEF DESCRIPTION OF THE DRAWINGS

Embodiments of the present invention will now be described, by way of example only by reference to the accompanying drawings in which:

FIG. 1 illustrates a plan view of the arrangements of components on a bolting machine.

FIG. 2 illustrates a side elevation of the apparatus of FIG. 1;

FIG. 3 illustrates a perspective view of a cyclone battery;

FIG. 4 illustrates a front elevation of the apparatus of FIG. 3;

FIG. 5 illustrates a plan view of the apparatus of FIG. 3;

FIG. 6 illustrates a side view of the apparatus of FIG. 3;

FIG. 7 illustrates a plan view of a wet scrubber assembly;

FIG. 8 illustrates a front elevation showing hidden detail of the apparatus of FIG. 7;

FIG. 9 illustrates a perspective view of the apparatus of FIG. 7;

FIG. 10 illustrates a side elevation of the apparatus of FIG. 7;

FIG. 11 illustrates a perspective view of a two cyclone battery for use with the present invention;

FIG. 12 illustrates a right side view of the apparatus of FIG. 11;

FIG. 13 illustrates a rear elevation of the apparatus of FIG. 11;

FIG. 14 illustrates a plan view of the apparatus of FIG. 11;

FIG. 15 illustrates a cross section through the left side of the apparatus of FIG. 14 in the direction of arrows AA;

FIG. 16 illustrates a schematic layout of a dust collection system;

FIGS. 17, 18 and 19 illustrate a bag which can be used with the cyclone dust collectors of the apparatus of FIGS. 3 to 6 or FIGS. 11 to 15.

### DETAILED DESCRIPTION OF THE EMBODIMENTS

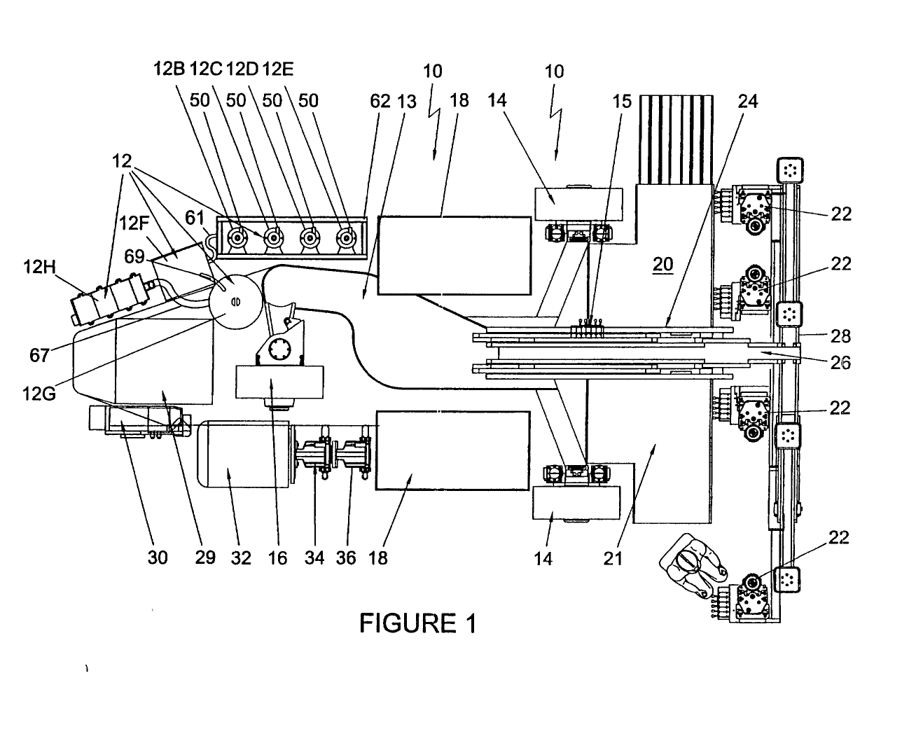

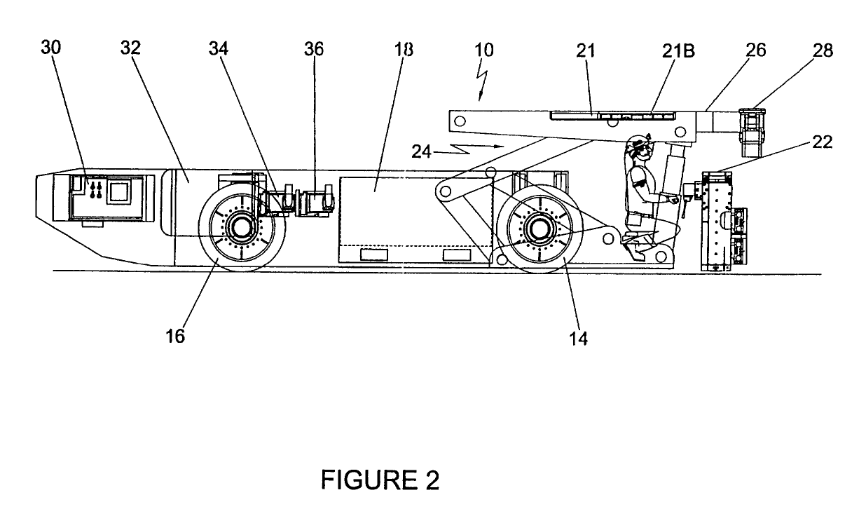

Illustrated in FIG. 1 is a mobile bolting apparatus such as that described in co-pending application PCT/AU00/00686 filed on Jun. 17, 2000 having International Publication Date of Dec. 28, 2000. The specification and drawings of which is incorporated herein by reference.

The illustration in FIG. 1 shows the main features of the bolting machine in a general layout view showing the placement of equipment and some of the major features of the bolting machine.

The bolting machine 10 has a dust collection system 12 located at the rear of the vehicle; three wheels being front wheels 14 and a rear steering wheel 16; storage pods 18 located around the middle of the vehicle the front and rear wheels 14 and 16 being extendable and retractable relative to the vehicle frame or chassis; a canopies 20 and 21 over the work area for the protection operators; a line of bolting rigs 22 with the outboard rigs being extendible from a tramming position as illustrated on the left side of machine 10 to a fully extended position outside the tramming width as illustrated on the right side of the machine 10.

Centrally positioned and at the forward end of the vehicle is a canopy support structure or lemniscate linkage 24 to which is pivotally mounted a temporary roof support structure 26 which carries the temporary roof support 28. Also at the front of the vehicle are four bolting rigs 22. At the rear of the machine 10 is a cable reel 29, a starter control box 30, and an electric motor 32 with two driven hydraulic pumps 34 and 36 to drive the dust collection system 12 and or other hydraulically driven components on the mining apparatus or vehicle.

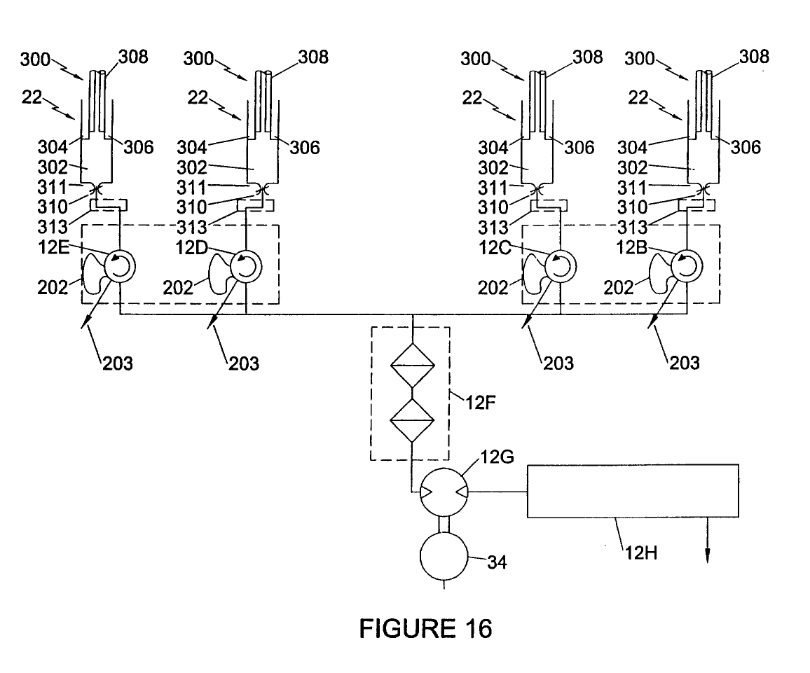

As illustrated in FIGS. 1 and 16, the dust collection system generally designated by the numeral 12 includes a battery 12A of four cyclonic separators. The individual cyclonic separators 12B, 12C and 12D and 12E have their inlets 50 connected to the drill units 22 so as to draw through hollow drill bits 308 (see FIG. 16) air and dust which results from that drilling process. The hoses are not illustrated which connect the inlets 50 to the base drill units 22.

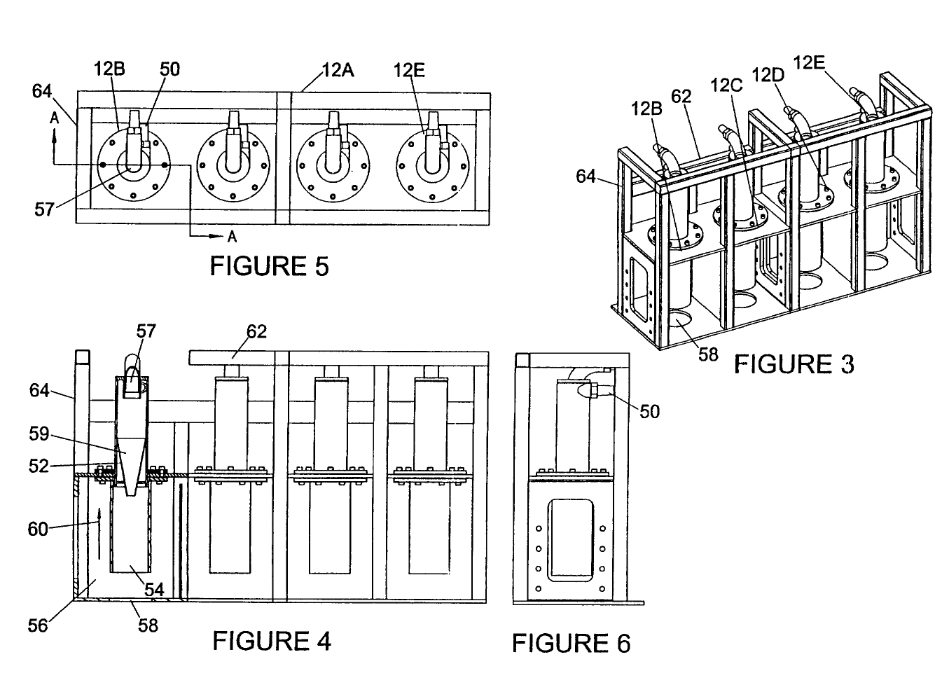

Cyclonic separators 12B through to 12E are illustrated in more detail in FIGS. 3 to 6. Each cyclonic separator has a tangentially located inlet 50 which forces incoming air into a spiral path down the separator tube 52. Particulate material separates from the spiralling air stream by a centrifugal effect. Separated particulate material will fall through outlet 54 into the chamber 56. At the base of the chamber 56 is an opening 58 which is closable by a door (not illustrated) which can be opened automatically. The air which has separated from the particulate material, is forced to exit the separator by central outlet 57 with a flow path which travels inwardly then upwardly above the cone 59. The air exiting each of the separators 12B through to 12E passes into a single conduit 61 preferably through the left side 64 of the cyclonic separator housing 62.

From the cyclonic separator housing 62, the air and any dust particulate still entrained in the air will pass into a filter 12F. The filter 12F is a cartridge filter comprising typically a two stage filter. The filter 12F is attached to a hydraulic vibrator so as to continually dislodge the build up of particulate material on the cartridge.

Air from the secondary filter 12F passes via a conduit 69 to a vacuum pump 12G powered by a hydraulic motor which obtains its power from one of the hydraulic pumps 34 or 36 attached to the electric motor 32. The air is drawn through the vacuum pump 12G and passes via a conduit 67 into a wet scrubber 12H.

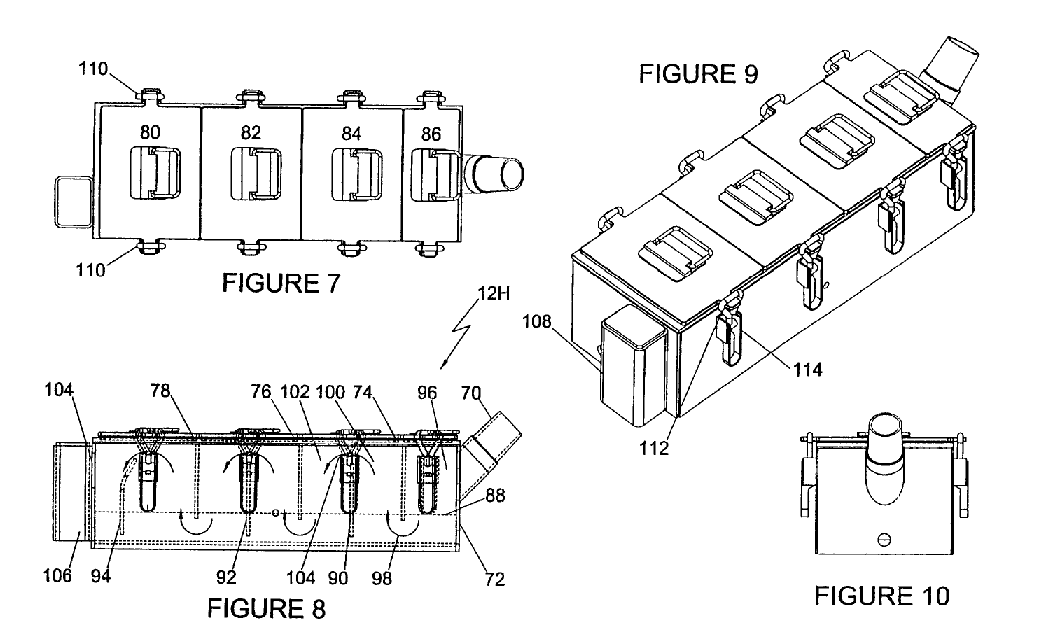

The wet scrubber 12H is the last filtration process before the air exits the dust collection system and is released to the mine atmosphere. The wet scrubber is illustrated in more detail in FIGS. 7 through to 10 and consists of a inlet spout 70 to convey the air and any entrained particulate material into the chambers of scrubber 12H. While this construction of a wet scrubber is detailed, it will be readily understood that other suitably constructed wet scrubbers or filters could be utilised.

The inlet 70 communicates with the interior of the main scrubber housing 72.

The main scrubber housing 72 is of a generally rectangular configuration and consists of a series of baffles which extend from the left hand side through to the right hand side of the housing 72 (that is into the page of FIG. 8). The first, third and fifth baffles 74, 76 and 78 define the sealing surfaces to co-operate and seal with covers 80, 82, 84 and 86 forcing any air entering the housing 72 to pass under the lower edge of each of the baffle 74, 76 and 78. The base of the housing 72 is filled with water which will be filled to a level approximately equivalent to the water line 88 of FIG. 8.

The lower end of the baffle 74 when the scrubber 12H is level will be between ½ and 2 inches (12 mm to 50 mm) below the surface of the water line 88.

The second, fourth and sixth baffles 90, 92 and 94 each extend from close to the base of the housing 72 and terminate below the covers 80, 82 and 84.

By this construction air passing through inlet 70, with the housing filled with water to the level indicated by water line 88, will be forced under the pressure in first chamber 96, through the water. The air and any entrained particulate material will pass through the water in the direction of arrow 98 into the second chamber 100. Thence under pressure from chamber 100 to chamber 102 in the direction of arrow 104 repeating the process until all the air has passed through the water three times thereby removing from the air any particulate material. The air will exit the scrubber 12H via outlet aperture 104 and outlet duct 106, as clean and dust free as the system is capable of producing.

The cover plates 80, 82, 84 and 86 are fitted with a gasket ring or o-ring and have fitting tabs 110 which are engaged by a latching loop 112 of an over-centre latch mechanism 114. By the latch mechanism 114, sufficient downward pressure is applied by the covers 80, 82, 84 and 86 to create an air tight seal via the gasket material.

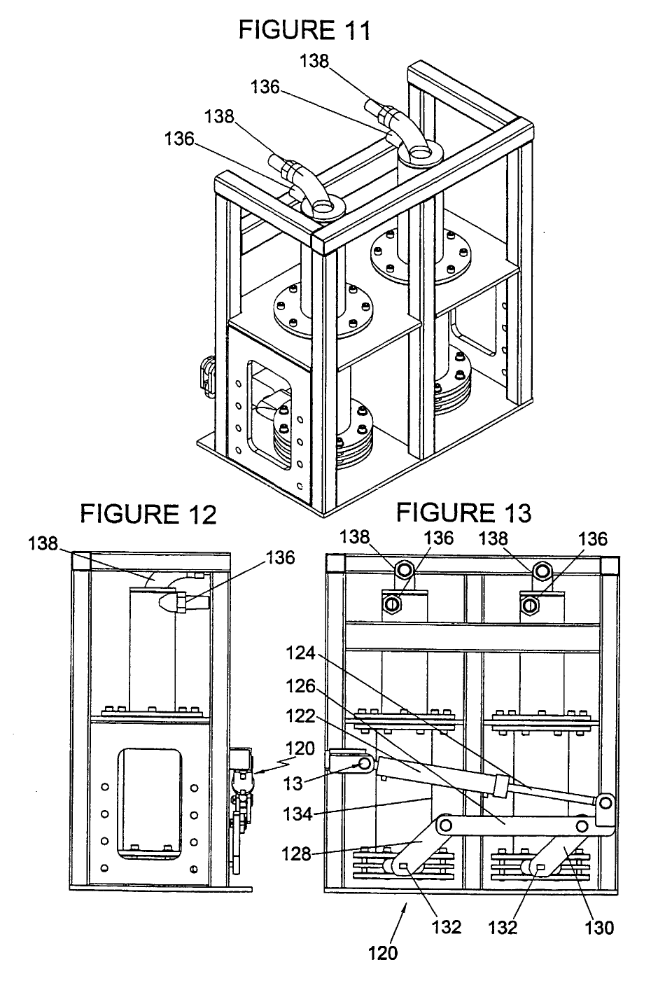

The embodiment illustrated in FIGS. 1 through to 10 shows the battery 12A on one side of the bolting machine. It may be preferable to provide two batteries, one on each side of the bolting machine and to this end a dual cyclonic housing is illustrated in FIGS. 11 through to 15. The housing 11 through to 15 is constructed similarly to the housing of the previous figures.

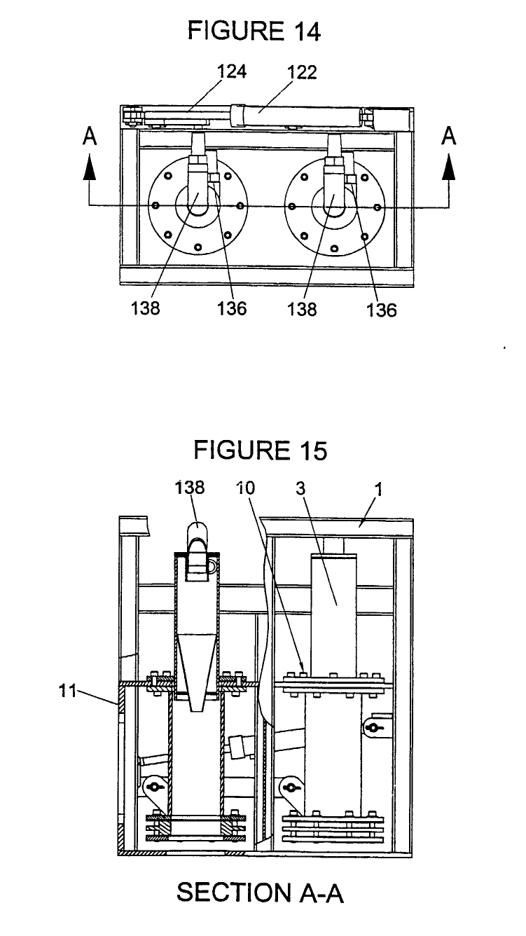

In FIGS. 11 to 15 is illustrated an automatic release mechanism 120 which has a hydraulic cylinder 122 with its piston rod 124 being pivotally connected to bar 126. The bar 126 which is rotatably connected to the cranks 128 and 130. The cranks 128 and 130 are connected to the shaft 132 of a butterfly valve (not visible) which closes the outlet in the base of the outlet tube 134.

The cyclonic separator of FIGS. 11 through to 15 has a tangential air inlet 136 which receives air from the drilling operations as described previously. The air spirals downward through the cyclonic separator and once the particulate has separated from the air, the air returns back through the centre of the separator and out through the central outlet 138 whereupon the air stream from one separator joins the air stream from another and passes on to the secondary filter 12F as described above with respect to the previous figures.

The cyclonic separators of the figures are illustrated as discharging dust onto the mine floor. This discharge process is preferably arranged so that when the temporary roof support is retracted the emptying mechanism 120, or the door opening mechanism of the apparatus of FIGS. 1 through to 10, is opened whereby any collected dust during the immediately preceding drilling operation is deposited onto the floor. The cyclonically separated particulate material tends to be comprised of relatively large sized particles as the fine sized particles tend to remain entrained in the cyclonic air stream. The larger sized particles tend to be of lesser risk to mine workers and thus deposition onto the mine floor is thought to have relatively little risk associated with it.

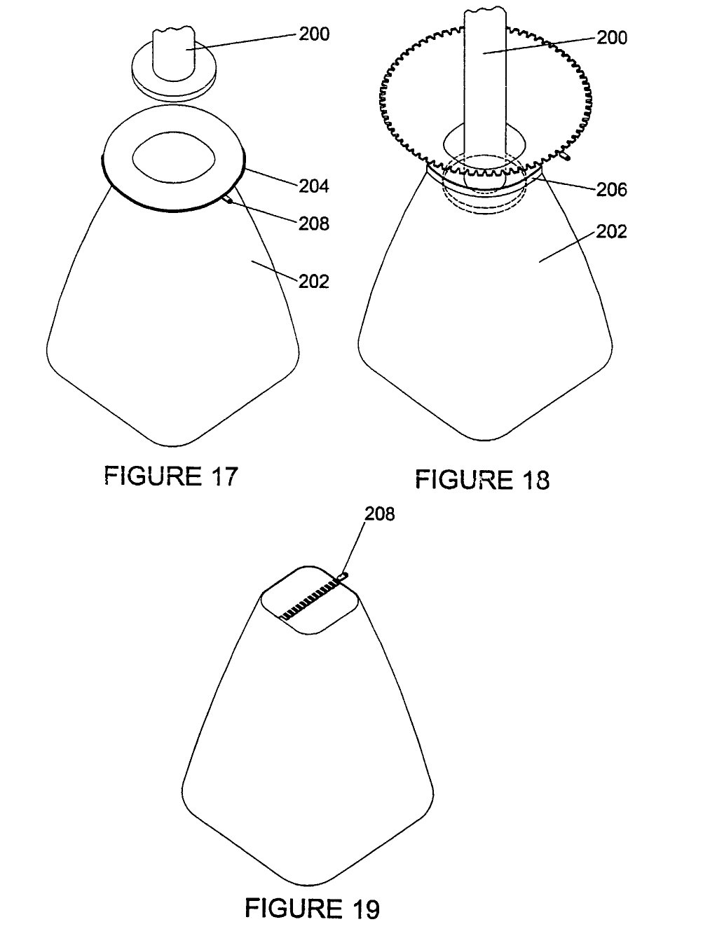

However, in order to further reduce risk to mine workers, the outlet cylinders attached to the cyclonic separators can be replaced with a flanged outlet 200 as illustrated in FIG. 17. The flanged outlet 200 allows for the attachment of a bag 202. The bag 202 has a zippered upper periphery 204 and this is opened out enabling the bag 202 to be placed on the flanged outlet 200 as illustrated in FIG. 18. This allows the bag 202 at the upper portions thereof to be clamped by means of an over-centre clamping ring 206 to the cylindrical wall of the flanged outlet 200. This will provide an air tight seal allowing the dust to fall into the bag 202.

Once the bag is full or at a predetermined point in the bolting operation (such as at a change of shift), an operator can remove the bag by unclamping the over-centre clamp 206, taking off the bag and closing the zipper as illustrated in FIG. 19 by pulling the zip closer 208 from one side of the bag opening to the other. This will allow the bags to be removed from the site without silica dust and other harmful dust particles re-entering the mine atmosphere. Preferably the bags are of a volume equal to approximately 38 liters so that the dust extracted will be a weight which is within the carrying limits of mining personnel, thereby ensuring that the bags can be readily lifted out of the cyclonic separator housings and onto transport to remove them from the mine entry.

The bag will preferably be of an air tight material, or if the enclosure in which the bag is located is made air tight then a non-air tight material can be used for the bag. Whilst a zipper closing arrangement is described, other closing systems such as VELCRO, clips etc could be used. If a bag of air tight material is used then a frame to hold the bag open may be required.

Illustrated in FIG. 16 is a schematic diagram of the apparatus described above except that a bag 202 is fitted to each of the cyclonic separators 12E, 12D, 12C and 12B.

As schematically illustrated the drill rig 22 has a drill chuck 300 which has a passage 302 therethrough. At a portion of the chuck 300 is a flange 304 which has an annular cylindrical seat 306 upon which a hollow drill rod 308 will sit at the base of the chuck 300. The base of the chuck 300 via passage 309 communicates with an inlet 311. The inlet 311 can supply sufficient restriction in the air flow, but if this is not enough, a restrictor or variable restrictor 310 may need to be used. The variable restrictor whilst illustrated in FIG. 16, will be understood as being a preferment.

When the pump 12G is activated, air will be drawn through the drill rod 308 the air inlet 311 and the restrictor 310 whereupon it flows through an intermediate manifold 313 and into the cyclonic separators 12B through to 12E. The particulate material will fall into the bags 202 whilst the air exits through the top of the cyclonic separator.

The outlets of the four separators feed into the secondary filter 12F. The filter 12F illustrated in FIG. 16 is a filter element which utilises two cartridges represented by the diamond shapes within the bounds of filter 12F. However, the filter 12F could instead be of a plate tip filter type which utilises two cartridges or another cyclonic separator which is capable of removing finer particulate. If a cyclonic separator is utilised a bag can be also utilised with the secondary filter 12F.

As air exiting the secondary filter 12F will be largely free of dust particles, the final filter 12H, such as the wet scrubber described above, will remove further dust particles. However, if desired a further cartridge filter could be utilised. Due to the presence of a primary and secondary stage of filtering the tertiary filter 12H could be sized to allow approximately six months' life before it requires changing at normal service and maintenance intervals.

If desired, in addition to the bag 202, facility can be provided, as described above, for the discharge of particulate material to the mine floor via a butterfly type valve member (such as that indicated by numeral 132 in FIG. 13), as schematically indicated by arrows 203 in FIG. 16. In this way a combination of both facilities can be used. For example the bag 202 can be used until full, and if the workers shift has not ended, the additional particulate material can be deposited on the mine floor to ensure minimal disruption to the shift and productivity.

One of the features of the dust collection system when bags are utilised, is that the absence of any one bag will mean that the whole dust collection system will not operate. This is because the system will draw air through the separator without a bag and not through the other restrictors and separators. Thus, providing the bags are not located in air tight enclosures, the dust collection system will fail to operate. By simply detecting loss of air flow from the drill rigs, an override switch can be activated by the detector and prevent the drill rigs being operated until such time as the missing bag is fitted. In this way the drill rigs can only be operated in a suitable working environment for the operators.

If desired, three hydraulic pumps can be provided instead of the two hydraulic pumps 34 and 36 so that two hydraulic pumps power two drilling rigs each, whilst one hydraulic pump could be utilised for the dust collection system and other power requirements.

If desired the flow path of air in the dust collection systems described above can terminate with a muffler or other sound absorbing apparatus. This can be provided as part of the secondary or tertiary filters such as the wet scrubber 12H.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

1 A mining apparatus dust collection component including a vessel to receive and circulate an airflow and an entrained particulate material; said vessel separating said particulate material from airflow by a centrifugal effect, said vessel including an inlet and an outlet for said airflow, said component including attachment means to attach a detachable bag to said vessel said detachable bag preventing air passing through it.

2 A mining apparatus dust collection component as claimed in claim 1 wherein the detachable bag is sealable after detachment from said vessel.

3 A mining apparatus dust collection components claimed in claim 1 or 2 wherein the detachable bag includes a zipper to seal said bag after detachment from said vessel.

4 A mining apparatus dust collection component as claimed in any one of the preceding claims wherein the vessel includes a structure to keep said bag in an open condition under the influence of a negative pressure.

5 A mining apparatus dust collection system as claimed in any one of the preceding claims wherein the structure is a wire frame which sits inside said bag.

6 A mining apparatus dust collection system including:
(a) at least one inlet associated with a respective drilling unit to draw air and dust into said system from a drill bit when said drilling unit is in use;
(b) at least a first stage of dust removal being a mining dust collection component as claimed in any one of claims 1 to 5 connected to at least one of said inlet;
(c) a vacuum pump to draw air and dust from said drilling unit.

7 A mining apparatus dust collection system as claimed in claim 6 wherein each dust collection component feeds outgoing air exiting said first stage into a single filter or separation component being a second stage.

8 A mining apparatus dust collection system as claimed in any one of claim 6 or 7 wherein said vacuum pump is downstream of said second stage.

9 A mining apparatus dust collection system as claimed in any one of claims 6 to 8 wherein said at least one inlet has a similar sized opening as provided through said drill unit and a drill bit connected to said drill unit.

10 A mining apparatus dust collection system as claimed in any one of claims 7 to 9 where there is included a third stage of filtration or separation whereby air exiting said vacuum pump passes through a filter or separator before exiting said dust collection system.

11 A mining apparatus dust collection system as claimed in any one of claims 6 to 10 wherein a restrictor or variable restrictor can be provided with communicable passage to said inlet and through which air and entrained particulate material will flow.

12 A method of operating a dust collection system said method including the collection of dust particles during a mining operation, passing same to at least one separator being a first stage the output of the at least one separator flowing to a filtration unit being a second stage, the filtration unit passing filtered air through to a vacuum pump.

13 A method as claimed in claim 12 wherein there is included a third stage of filtering or separation downstream of the outlet of the vacuum pump.

14 A method as claimed in any one of claim 12 or 13, wherein at least one separator of said first and or said second stage and or said third stage has a door to cover an outlet therefrom whereby when a predetermined operation occurs on the mining apparatus the outlet will open thus depositing any separated particulate onto the ground.

15 A method as claimed in claim 14 wherein the emptying operation is automatically timed to be completed before the next said predetermined operation begins.

16 A method as claimed in any one of claims 12 to 15 wherein said apparatus is a bolting apparatus.

17 A method as claimed in any one of claims 14 or 15 wherein said predetermined operation is the retraction of a temporary roof support.

18 A method as claimed in claim 17 wherein the outlet closes the next time that the temporary roof support is moved so as to engage a roof system.

19 A method as claimed in claim 12 or 13 wherein sealable containers receive dust from said first or second stages.

20 A method as claimed in claim 19 wherein the absence or rupture of one container prevents a mining operation from occurring.

21 A method as claimed in claim 19 or 20 wherein said containers are flexible sealable bags.
